(19) United States
(12) Patent Application Publication
(10) Pub. No.: US 2009/0247121 A1
(43) Pub. Date: Oct. 1, 2009

(54) Customer sales and service calls using cell phone, flat fee local and long distance calling plans, digital voice and internet calling plans

(76) Inventor: William T. Morrison, JR., Jacksonville, FL (US)

Correspondence Address: William T. Morrison, Jr., 4917 Top Royal Lane, Jacksonville, FL, 32277, US

(21) Appl. No.: 12/383,216

(22) Filed: Mar. 20, 2009

Related U.S. Application Data
(60) Provisional application No. 61/070,818, filed on Mar. 26, 2008.

(51) Int. Cl. H04M 11/00

(52) U.S. Cl. 455/406

(57) ABSTRACT

A system and methodology that allows customers to use cell phones, flat fee long distance calling plans or internet calling to obtain sales and service by calling toll free telephone numbers provided by stores or businesses interested in providing these services by telephone. Customers with these calling capabilities are more concerned with minutes used than the telephone number called. Since free long distance calling is usually included in the above plans, it is not advantages for companies to pay the cost of toll free phone calls for these customers. This invention will allow customers with the above calling plans to switch or choose between toll free phone numbers and local phone numbers. Each time a customer chooses or switches from a toll free number to a local number it will save money for the company or business being called.

### CROSS-REFERENCE TO RELATED APPLICATION

This application is entitled to the benefit of, and claims priority to provisional U.S. patent application Ser. No. 61/070,818 filed Mar. 26, 2008, and entitled “CUSTOMER SALES AND SERVICE CALLS USING CELL PHONE, FLAT FEE LOCAL AND LONG DISTANCE CALLING PLANS, DIGITAL VOICE AND INTERNET CALLING PLANS,” the entirety of which is incorporated herein by reference.

### FIELD OF THE INVENTION

The present invention relates to a system and a methodology for customers to obtain sales and service assistance by calling toll free phone numbers provided by companies offering product sales or services over the telephone. This invention will allow callers using cell phone, flat fee local and long distance calling plans, digital voice and internet calling plans to obtain product sales or service assistance by using local phone numbers rather or in addition to toll free phone numbers provided by the company being contacted.

### BACKGROUND OF THE INVENTION

Many companies have consolidated telephone sales and customer service from local branches, stores or offices into state, regional or even national locations and provided their customers with toll free telephone numbers to maintain contact with their customers in a way so as not to add to their customers' cost. These toll free telephone numbers are commonly referred to as 800 numbers. However, they may include any number of three digit numbers such as 800 numbers, 866 numbers, 877 numbers, 888 numbers etc..

While the cost of providing customers with toll free telephone numbers has come down significantly over the last several years, it is still very expensive for companies with high volume of customer calls to provide this service for free. Even though the toll free telephone sales and service can be expensive for a company, it is still beneficial for most companies to consolidate their telephone sales and service into state, regional or national locations rather than perform this telephone sales and service at every store or office location.

Significant changes have occurred over the last several years from the customers standpoint as it relates to doing business over the telephone. The tremendous increase in cell phone usage has changed customer patterns as to how and when they are able to utilize telephone sales and service. Most cell phone plans allow for free long distance calling and many plans provide unlimited usage. Along with cell phone usage increases, is the emergence of unlimited local and long distance calling plans using land lines. Internet calling is now beginning to catch on. All of these plans have one thing in common, it doesn't matter whether you are calling a local telephone number or a long distance telephone number from a customer's cost standpoint. If there is a usage charge for most plans it is based on the number of minutes used not the telephone number called.

Many telephone calls are re-routed in today's environment. A customer may dial a local telephone number thinking they are going to be talking to someone in their city about sales or service when in fact that call may be transferred to a consolidated telephone sales and service call center in another city or state. Routing or transferring calls behind the scene is a common practice in the business world today.

### SUMMARY OF THE INVENTION

It is believed that there is a financial benefit to businesses in implementing a plan to switch cell phone calls as well as flat rate local and long distance calls out of the toll free telephone communication network where the businesses have to pay a per minute usage charge to a local telephone number with a flat monthly fee regardless of the number of calls received or minutes used.

This invention is a methodology and system to move call volume from a toll free telephone network to a local telephone network in the city where the telephone sales and service call center is located thus eliminating the per minute usage charges for the business providing this toll free option.

The methodology and system used to move call volume from toll free telephone network would be to have the customer call a local number for the city where sales and customer service call center is located. Once connection is made, the customer would be given options to select whether they are using a cell phone, flat fee local and long distance calling plan or some other telephone calling plan that does not have a direct cost to the customer for the call. If the customer selects yes, they would remain on the local telephone network dialed. If the customer selects no, they would be switched to a toll free telephone network to eliminate the cost for the customer.

Another methodology and system would be for the customer to dial a number that is in a toll free telephone network (generally referred to as 800 service) and once the connection is made the customer would be given the option to select whether they are using a cell phone, flat fee local and long distance calling plan or some other telephone calling plan that does not have a direct cost to the customer for the call. If the customer selects yes, they would be switched to a local telephone network for the business they are contacting. This local number would be a number that is considered local for the location where the telephone sales and service call center is located. If the customer selects no, they would remain on the toll free telephone network dialed.

Another methodology and system for the businesses offering customer sales and service via telephone, would be to provide their customers with the option of dialing numbers that are local for that company or the option of calling a toll free number for customer sales and service. Both local and toll free telephone numbers would be provided to the customer. These numbers could be published in their advertisements, phone books and web pages. When a customer dials one of these numbers, they may remain in that particular telephone network. However, the business could still offer the options to switch telephone networks even on these numbers.

### BRIEF DESCRIPTION OF THE DRAWINGS

The present invention will become more fully understood from the detailed description and the accompanying drawings.

FIG. 1 is a schematic block diagram representatively illustrating the sequence of steps in obtaining telephone sales and service via the customer calling a telephone number that is in a toll free telephone network—example 800 series numbers.

FIG. 2 is a schematic block diagram representatively illustrating the sequence of steps in obtaining telephone sales and service via the customer calling a telephone number that is a local number for the business offering this service.

### DESCRIPTION OF EMBODIMENTS

The following description of the embodiment(s) of the present invention is merely exemplary in nature and is in no way intended to limit the invention, its application or uses. While the accompanying drawings and the following description thereof disclose the present invention in relation to embodiments thereof particularly adapted for use with cell phones, flat rate local and long distance calling plans and internet calling plans, the system and methodology of the present invention is neither intended to be interpreted nor understood to be limited to applications or embodiments utilizing these limited forms of communication devices and plans.

This present invention has a broad potential application and utility, which is contemplated to be adaptable to a wide range of businesses and companies and other forms of transactions in which customers are provided sales and service opportunities via telephone communication networks and systems where the businesses and companies are interested in providing this service a no cost to their customers while at the same time lowering their own cost. Fundamentally, therefore, it is to be understood that the present invention is contemplated to be applicable and usable by substantially any entity that offers customer sales and service over telephone networks.

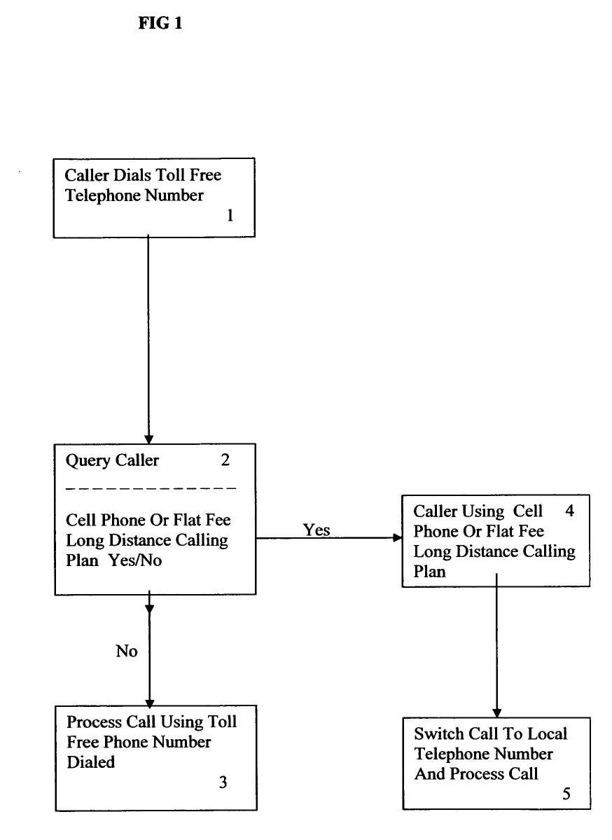

Referring now to the accompanying drawing, FIG. 1, (box 1) represents a customer who is attempting to obtain sales and service assistance via calling a toll free number offered by the business or company being called. This company could be a large retail sales corporation or a small business. It could also be a company that offers service only such as medical profession businesses.

FIG. 1. Once the customer makes contact via dialing the toll free number, (box 2) represents the options the caller would be given to continue with the call. The customer would be asked if they are using a cell phone or a flat fee local and long distance calling plan. If the customer selects option no, the call would proceed to (box 3). If the customer selects option yes, the call would proceed to (box 4).

FIG. 1. If the customer answered no in (box 2), the call would continue to be processed as dialed represented in (box 3). There would not be any switching of the telephone call between telephone networks in this case and the customer would be serviced on the toll free telephone network dialed.

FIG. 1. In the embodiment represented by (box 4) the caller indicated that the call is being made via the use of a cell phone or a flat fee local and long distance calling plan. In this case there is not a difference in cost to the customer as to whether the call continues on the toll free telephone network or not. However, there is a significant cost savings to the business or company being called.

FIG. 1. In the embodiment represented by (box 5) the call is switched from the toll free telephone network provided by the business or company called to a local telephone network located in the city where the sales and service call center is located. The customer would be serviced on the local telephone network at no additional cost to the customer but a cost savings to the business or company called.

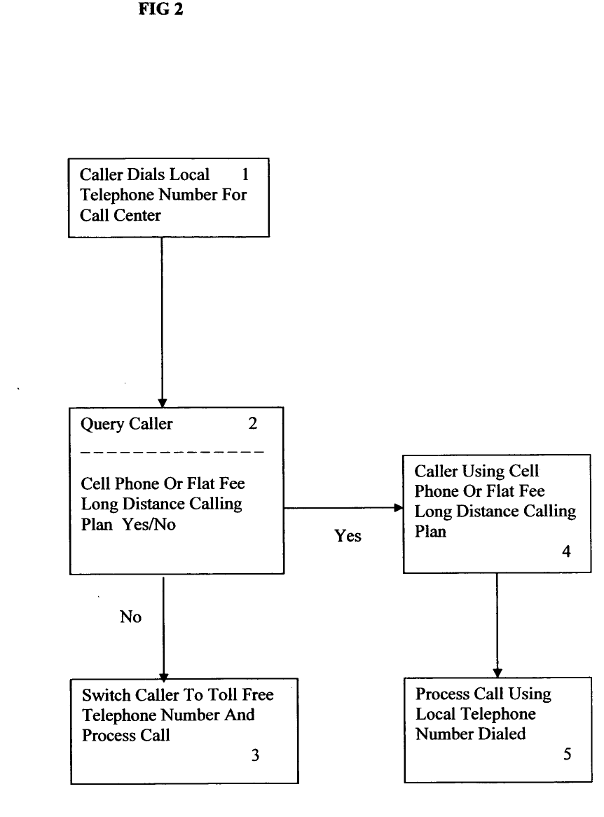

Referring to the accompanying drawing, FIG. 2, (box 1) represents a customer who is attempting to obtain sales and service assistance via calling a local number provided by the business or company being contacted. This telephone number would be a local number for the city where the telephone sales and service operation is performed. The company could be a large retail sales corporation or a small business. It could also be a company that offers service only such as medical profession businesses.

FIG. 2. Once the customer makes contact via dialing the local telephone number, (box 2) represents the options the customer would be given to continue with the call. The customer would be asked if they are using a cell phone or a flat fee local and long distance calling plan. If the customer selects option no, the call would proceed to (box 3). If the customer selects option yes, the call would proceed to (box 4).

FIG. 2. If the customer selected no in (box 2), the call would be switched to the toll free telephone network (box 3) provided by the business or company called. The customer would be serviced on the toll free network.

FIG. 2. In the embodiment represented by (box 4) the caller indicated that the call is being made via a cell phone or a flat fee local and long distance calling plan. In this case there is no difference in cost to the customer as to whether the call continues on the local telephone network dialed or is switched to a toll free telephone network. However, there is a significant cost savings to the business or company being called.

FIG. 2. In the embodiment represented by (box 5) the call would be processed using the local telephone network dialed and there would not be any switching of this phone call. The customer's request for sales or service would be performed.

What is claimed is:

1. A methodology for making phone calls to local and 800 series telephone numbers via the use of a cell phone comprised of the following steps:
(a) customer enters into a contract with a cell phone service provider;
(b) selects a cell phone service plan that best suits customer's need relative to making local and long distance calls;
(c) selects a cell phone service plan that provides free long distance service to the telephone numbers in customer's desired calling zone;
(d) selects a cell phone unit that meets customer's desires.

2. A methodology and system used by businesses and companies to provide their customers and prospective customers with toll free telephone numbers to receive sales and service calls as well as local telephone numbers for customers in the calling area where the sales and service call center is located as follows:
(a) contract with a telephone service provider that offers what is commonly referred to as 800 phone service;
(b) toll free telephone numbers could be 800 series, 866 series, 877 series or 888 series;
(c) contract with a telephone service provider to provide local telephone number or numbers for customers in the local calling area of the sales and service call center;
(d) implement a telephone network system that allows calls to be transferred between toll free telephone numbers and local telephone numbers;
(e) develop a telephone network system that intervenes in each telephone call to give the caller the option of switching between toll free telephone numbers and local telephone numbers.

3. A methodology for using a cell phone according to claim 1, to dial a business or company's sales and service call center for assistance utilizing a 800 series phone number provided by the business or company according to claim 2.

4. A methodology for using a cell phone according to claim 1, to dial a business or company's sales and service department for assistance utilizing a local telephone number provided by the business or company according to claim 2.

5. A methodology for making telephone calls using land based telephone systems utilizing telephone calling service plan that provides flat fee long distance calling as follows:
(a) customer contracts with a telephone service provider for a calling plan that charges a flat fee for local and long distance calls;
(b) number of calls and minutes used are usually unlimited under these plans;
(c) calls originate from customer's home phone network.

6. A methodology for making telephone calls according to claim 5, using a home telephone system to dial a business or company's customer sales and service call center using a toll free number according to claim 2.

7. A methodology for making telephone calls according to claim 5, using a home telephone system to dial a business or company's customer sales and service operation center using a local telephone according to claim 2.

8. (canceled)

9. A methodology and system according to claim 2, that allows customers the option to switch in and out of toll free telephone networks as well as in and out of local telephone networks.

10. A methodology and system according to claim 2, that allows the staff of the customer sales and service call center to service the caller using the most cost effective telephone network for both the business or company as well as the customer making the call.
